(19) United States
(12) Patent Application Publication
(10) Pub. No.: US 2007/0111166 A1
(43) Pub. Date: May 17, 2007

(54) Method for the identification of dental plaque, a toothbrush for applying said method and a composition to be used with same

(76) Inventor: Edmundo Martin Dursi, Ciudad Autonoma de Buenos Aires (AR)

Correspondence Address: DEFILLO & ASSOCIATES, INC., P.O. Box 14104, Clearwater, FL, 33766, US

(21) Appl. No.: 11/524,217

(22) Filed: Sep. 20, 2006

(30) Foreign Application Priority Data
Nov. 11, 2005 (AR) P 050104732

(51) Int. Cl. A61C 5/00; A61C 3/00

(52) U.S. Cl. 433/215; 433/29

(57) ABSTRACT

This invention refers to a method for the identification of dental plaque, a toothbrush for carrying out said method, and a dental composition, a toothpaste in any of its forms, i.e., liquid, gel, spray, with the addition of fluorescein to be used with same. This composition shall facilitate the visualization, detection, removal, control and certification of DP by the user him/herself, avoiding the development and generation of all DP-related diseases. It is known that the dental plaque is invisible to the human eye, and it is only detectable when it has certain width. This invention proposes the incorporation of fluorescein to a toothpaste, gel, spray or liquid and a visible light for the detection of said plaque. This light shall be incorporated to the toothbrush and/or adjoined to it as an accessory applicable to any type of toothbrush as a kit, with the use of adhesives or with an adhesion, filting or attachment system to the toothbrush's handle.

### TECHNICAL FIELD

This invention refers to a method for the identification of dental plaque, a toothbrush to apply this method, and a composition to be used with same. This composition shall facilitate the visualization, detection, removal and assurance to have eliminated the dental plaque by the user him/herself, controlling and avoiding the development of dental plaque-related (DP) diseases in both soft and hard tissues.

### BACKGROUND OF THE INVENTION

It is known that DP is invisible to the human eye, being only detectable when it acquires certain width or dimension, combined with remains of foods and other elements in the mouth.

Although it is invisible, said DP has a pathogen power, therefore it is very important to detect and remove it at early stages.

Today, one of the better ways to visualize DP, is to attend the dentist, who, with the use of dyes for staining DP, shall detect same. Those dyes are known as plaque disclosers. Thus, the dentist identifies and removes plaque and gives recommendations to the patient on an appropriate oral hygiene and tooth brushing, and the patient shall have to follow this advice to continue with the treatment. It has to be noted that DP forms constantly, and reaches its maximums concentration before 24 h.

It is very important to inform and educate the patients on the methods for removing DP. In order to achieve full efficiency, these procedures should be planned by the dentist and followed by the patient. This method, the subject of this patent, is aimed at arising the patients' interest to achieve a successful DP removal. Any brushing technique and toothbrush would be appropriate, and it shall depend on the patient's skills and the existing pathology, but the most important thing is the correct visualization of DP, so as to remove it and confirm its elimination.

One of the dyes known so far is erythrosine. There are also two-tone dyes that stain the oldest plaque in color blue, and the newest one pink.

The fact that those plaque disclosers may be self-applied by the patient at home or wherever he/she is, shall allow to fully control DP, allowing visualization, detection, and removal of same. Thus, we shall facilitate control and eradication of DP.

### SUMMARY OF THE INVENTION

There are several plaque disclosers in the market, and the most famous is erythrosine in the form of tablets that color dental plaque.

One of the most known disclosers in the market, Oral B®, uses 5.217 Mg of erythrosine.

Use of this tablet consists of flossing the mouth with water, then chewing a tablet to dissolve it in saliva, and passing it through the inter-dental spaces so as to make plaque visible. The oldest plaque (that of more than 48 hours) shall be dyed in blue, and the most recent one (of less than 24 hours) in red.

With this invention's method, it is the patient himself, at home or wherever he/she is, who will use a substance, solution, composition, or toothpaste, gel, spray or floss containing the plaque-disclosing compound, i.e. fluorescein, to make plaque visible with the use of blue light or a diode attached to the toothbrush. This light shall be oriented towards the bushing direction to highlight and disclose DP. The incorporation of light to the toothbrush's handle, as compared to other positions evaluated, allows a better visibility of DP by the user.

There are several alternatives for the incorporation of light to the toothbrush that shall be described in the foregoing paragraphs.

As we know, there is a wide variety of toothbrushes, including electric, battery and manual toothbrushes. In all cases, the source of light or diode shall be inserted in the toothbrush's body or handle to allow the normal change of bristle heads and lighting all the brushing area.

For manual toothbrushes, the light source or diode shall be attached to the toothbrush's body or handle, in the middle part, by means of an adhesive means or universal fitting, given the wide variety of toothbrushes and handles.

Light shall be visible, therefore, the user shall know is functioning.

### BRIEF DESCRIPTION OF THE DRAWINGS

In order to illustrate this invention, seven schematic drawings have been attached, with the preferred form of performance as an example, where:

FIGS. 1a and 1b show both the frontal and lateral views of the first form of performance.

FIG. 2 is a perspective view of the FIG. 1 toothbrush.

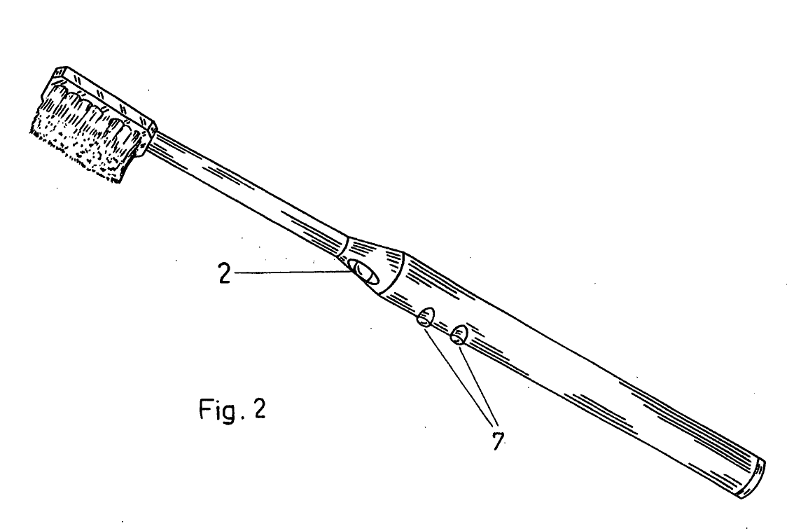

FIGS. 3a and 3b show frontal and lateral views of a toothbrush pursuant to a second form of performance.

FIG. 4 is a perspective view pursuant to FIGS. 3a and 3b.

FIGS. 5a and 5b are the frontal views of both the toothbrush and the light source pursuant to the second preferred performance modality with the parts shown independently.

FIGS. 6a and 6b illustrate frontal views of both the toothbrush and the light source, where the light source has and adhesive tape with a different configuration.

FIG. 7 shows an electric toothbrush incorporating the light source, as a third modality for the performance of this invention.

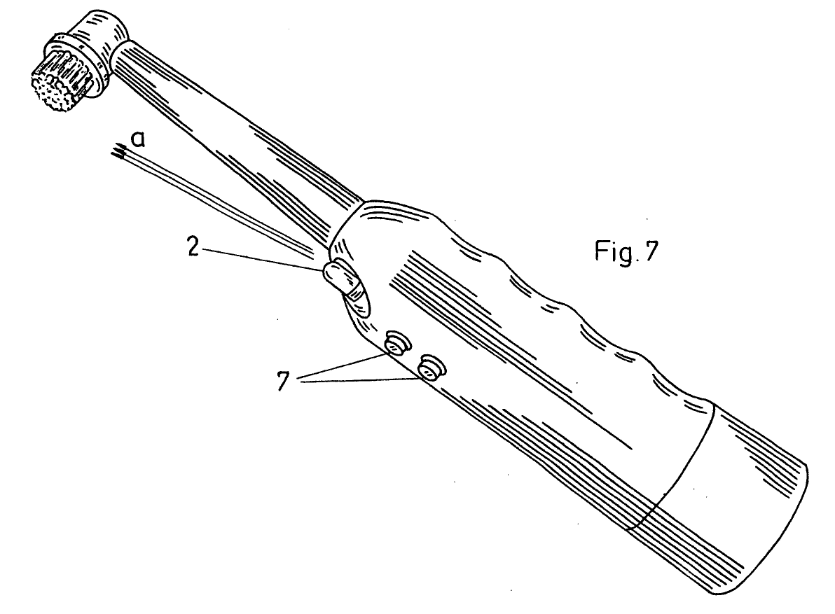

In the above-mentioned figures, equal reference numbers refer to equal or similar elements.

### DETAILED DESCRIPTION OF THE INVENTION

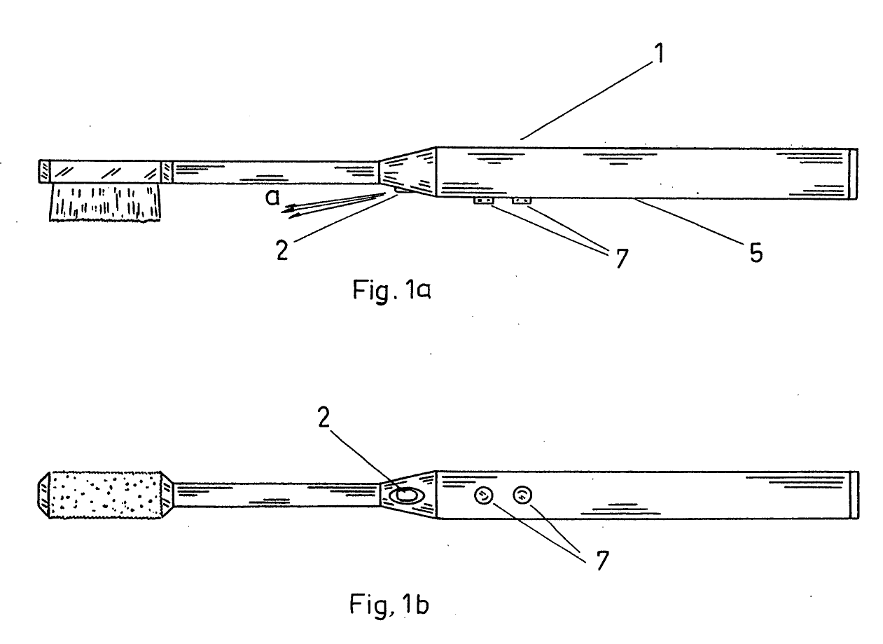

In FIGS. 1a and 1b the light source 2 has been incorporated to the toothbrush's handle 5 of toothbrush 1, the batteries provide energy to both the toothbrush and the light, and 7 is the on-off switch.

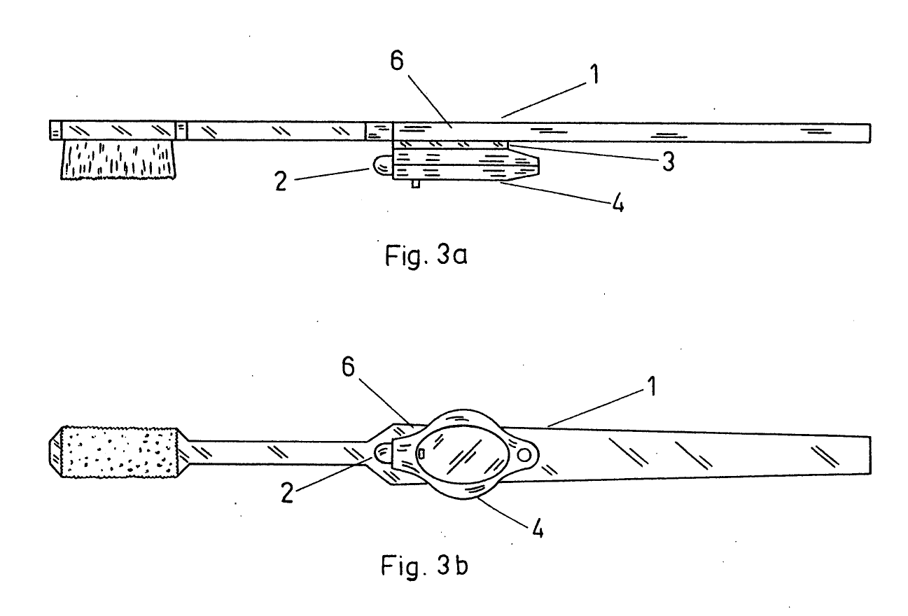

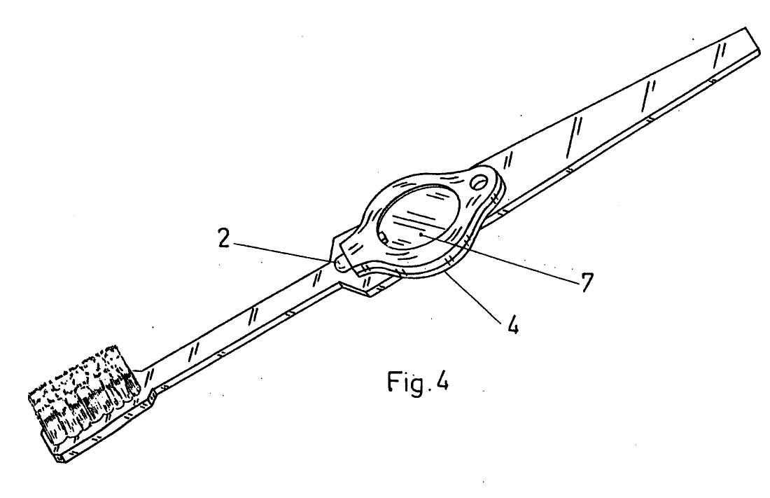

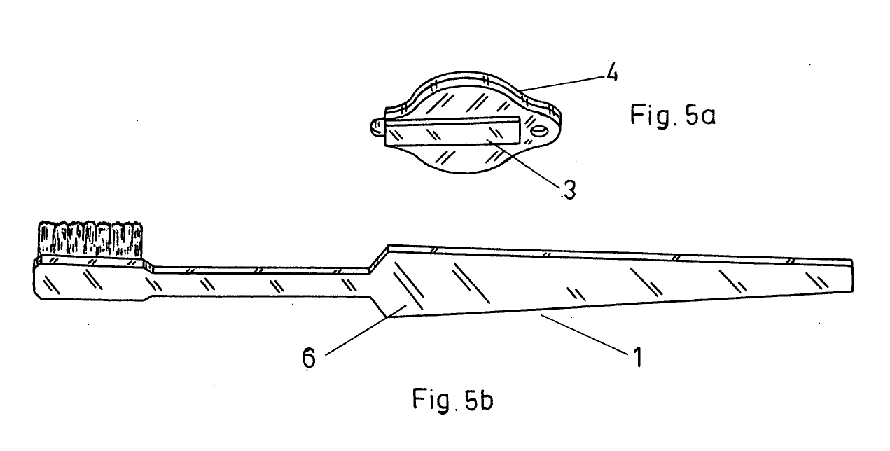

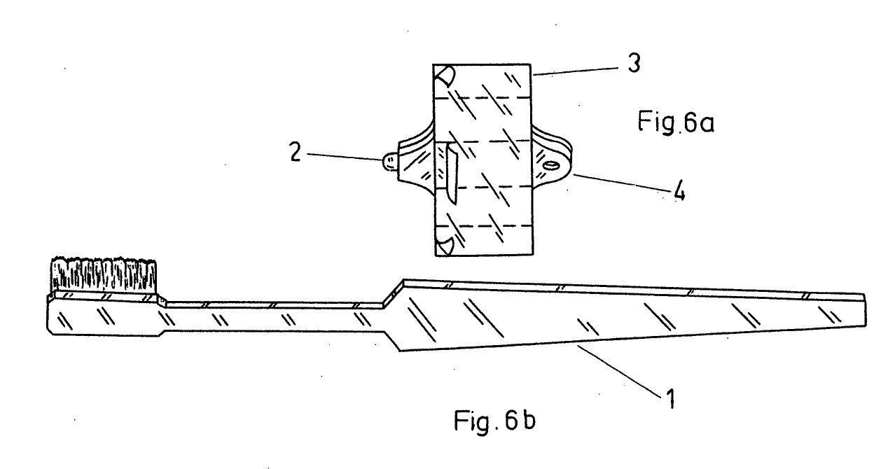

As it may be seen in the attached FIGS. 3, 4, 5 and 6, the toothbrushes 1 have a light source 2 on their handles, which have been attached by an adhesive means 3. It can be observed that the light source 2 has been attached to a body 4. Another possible modality for this invention is that said body 4 has fitting flaps to the toothbrush's handle, and/or rings called rubber O'rings that may be used in any toothbrush.

As it may be observed, said light source 2 shall be incorporated to the portion 6 of the body 1, which shall include one of the modalities of performance, an adhesive means 3, to allow attachment to the central part of the toothbrush and thus visualize the zone of the mouth being brushed and achieve fluorescence in the dental substance's composition.

Regarding the composition of the toothpaste, it shall include the same compounds of a regular one with the addition of fluorescein in a percentage ranging 1 to 10%. Said percentage shall make possible the staining and visualization of the dental plaque after lighting same with the light source attached to the toothbrush. The zone of the tooth and/or mucosa with dental plaque shall acquire a fluorescent color easily identifiable and differentiable from the rest of mouth tissues. Once the zone stained by fluorescein disappears after tooth brushing, the patient or user shall know that plaque has been completely removed, and that he/she performed a correct oral hygiene.

We attest that the above is only one way of performance of this invention and, any other performance way that does not go apart from the below indicated claims shall be considered comprised by this invention.

1-5. (canceled)

6. A method for the identification of dental plaque comprising:
a) placing a toothpaste containing fluorescein on toothbrush's bristles;
b) extending the toothpaste over the whole surface of the mouth; and
c) lighthing the brushing area with a light source, wherein the light source generates fluorescence on the toothpaste to identify the areas with dental plaque.

7. A toothbrush for identify dental plaque comprising:
a handle and bristles;
a light source mounted on the toothbrush, wherein the light source is oriented towards the bristles.

8. The toothbrush according to claim 7 wherein the light source is placed on the handle of the toothbrush.

9. A dental composition to be used with the method of claim 6 wherein the composition comprises a toothpaste, gel, spray, or liquid containing fluorescein.

10. A dental composition according to claim 9 wherein the fluorescein contents range between 1 and 10% the weigh of the dental composition.
